(19) United States
(12) Patent Application Publication
(10) Pub. No.: US 2015/0317637 A1
(43) Pub. Date: Nov. 5, 2015

(54) MULTIBANK BIOMETRIC AUTHENTICATION SYSTEM APPLIED IN AUTOMATIC TELLER MACHINES EQUIPPED WITH BIOMETRIC SENSORS

(71) Applicant: TECNOLOGIA BANCÁRIA S.A., Barueri (BR)

(72) Inventors: Carlos Issao Kuribara, Barueri (BR); Rodrigo Paiva Inácio Lima, Sao Paulo (BR); Elcio Seiji Tabuti, Sao Paulo (BR); Fabiana Tiemi Oda Katanosaka, Sao Paulo (BR); Simone Reboreda Simões, Sao Paulo (BR)

(21) Appl. No.: 14/697,852

(22) Filed: Apr. 28, 2015

(30) Foreign Application Priority Data
Apr. 28, 2014 (BR) 10-2014-010137-3

(51) Int. Cl. G06Q 20/40; G06Q 20/10

(52) U.S. Cl. CPC G06Q 20/40145; G06Q 20/1085

(57) ABSTRACT

“MULTIBANK BIOMETRIC AUTHENTICATION SYSTEM APPLIED IN AUTOMATIC TELLER MACHINES EQUIPPED WITH BIOMETRIC SENSORS”, the “MULTIBANK BIOMETRIC AUTHENTICATION SYSTEM APPLIED IN AUTOMATIC TELLER MACHINES WITH BIOMETRIC SENSORS” refers, more specifically, to the use of automatic teller machines to perform transactions with multibank biometric authentication with one, two or three biometric sensors; the system proposed enables transactions to be performed requiring only the biometric authentication or requiring contingency devices, i.e., positive identification, TAN CODE, TOKEN, or further, that it is realized requesting the combination of devices, being the referred solution developed to reduce costs and increase accuracy in the user (U) authentication, providing full security in financial transactions, on a configurable customized manner to attend the needs of the financial institutions (16) and users (U).

### TECHNICAL FIELD

This specification relates to a patent application of invention that foresees a multibank biometric authentication system applied in automatic teller machines, which preferably has three biometric sensors.

### BACKGROUND OF THE ART

Nowadays, financial institutions are replacing their security solutions for bank account access through ATM, which occurs by entering personal passwords, security codes, personal information and other combinations of numerical, syllabic and similar information, which are generally entered by users upon accessing, via biometric authentication solutions.

Currently, on the financial institutions branch, there is no provision of a system that enables the biometric authentication of several banks in one ATM network used by such banks, where such biometric authentication can be based on at least three different sensors.

The applicant acts within the context described above, being a company that manages a network of multibank ATMs that are used by users of several financial institutions, where each one of it must preferably adopt three security solutions with biometric authentication.

The applicant, hereinafter referred to as “Company X” in this specification, after a long development period enabled the system to attend users of financial institutions adopting different biometric authentication solutions.

### BRIEF DESCRIPTION OF THE INVENTION

The Company “X”, interested in providing improvements regarding security when using automatic teller machines, after countless researches and tests, created and developed this “MULTIBANK BIOMETRIC AUTHENTICATION SYSTEM APPLIED IN AUTOMATIC TELLER MACHINES WITH BIOMETRIC SENSORS”, which must be placed with highlights among its counterparts and personalized before the consumer market because it presents a multibank biometric authentication system preferably using three biometric sensors, system where financial institutions may choose to adopt one of the biometric technologies on the market, which may include fingerprint biometric authentication (using fingerprint sensors), vein biometric authentication (using palm vein or finger vein sensors), to authenticate its users. It is worth underlining that the herein claimed matter does not approach technical and/or functional characteristics of these biometric sensors genres.

The system created by the financial institutions via information of physical characteristics of each user preferably uses three market biometric authentication technologies—fingerprint biometric authentication (using fingerprint sensor), vein biometric authentication (using palm vein or finger vein sensors), considering that, this way, the usage and access to bank account of each user by ATM of the Company “X” will be performed with biometric technologies selected by each one of the financial institutions.

### DESCRIPTION OF THE DRAWINGS

The “Multibank Biometric Authentication System Applied in Automatic Teller Machines Preferably with Three Biometric Sensors” will be comprehensively described with reference to drawings related below, where:

FIG. 1 illustrates the message exchange performed between ATM 1, Company “X” and the financial institution 16 to perform a transaction with biometric authentication (2, 3 or 4).

FIG. 2 illustrates the security diagram applied to the multibank biometric and multibiometry solution, considering that each financial institution (16A, 16B or 16C) will exchange biometric information through a specific encryption key and can be dynamically exchanged with the Company “X”. The Company “X” will translate the template (15A, 15B or 15C) for the encryption key of the ATM (28A or 28B). The Company “X” will be responsible for the ATM terminal key. Each ATM will have its encryption key and it can be exchanged dynamically.

FIG. 3 illustrates the software architecture on the ATM for multibiometry.

FIG. 4 illustrates the message exchange diagram performed between the ATM 1 and the financial institution 16 to search for the security device (biometric templates) that will be used to authenticate the User U on the ATM 1.

FIG. 5 illustrates the treatment sequence when there is biometric authentication error of the User U on the ATM.

According to the presented on drawings above displayed, on the System proposed by the Company “X”, the biometric information of User Us are required from the financial institution informing which biometric sensors are available to be used by its User Us on the ATM in use. The financial institution verifies the biometric sensors available on the ATM and sends the corresponding biometric characteristics (biometric templates encrypted) for authentication of User U using the market biometric technology selected by the financial institution, being, for example, palm vein, finger vein or fingerprint, or even any other technology that demonstrates being proper) and performs transaction via biometric authentication.

Firstly, a biometric key is defined between the financial institution 16 and the Host of the Company “X” and a key for each ATM between the Host of the Company “X” and ATMs, with this key being periodically changed.

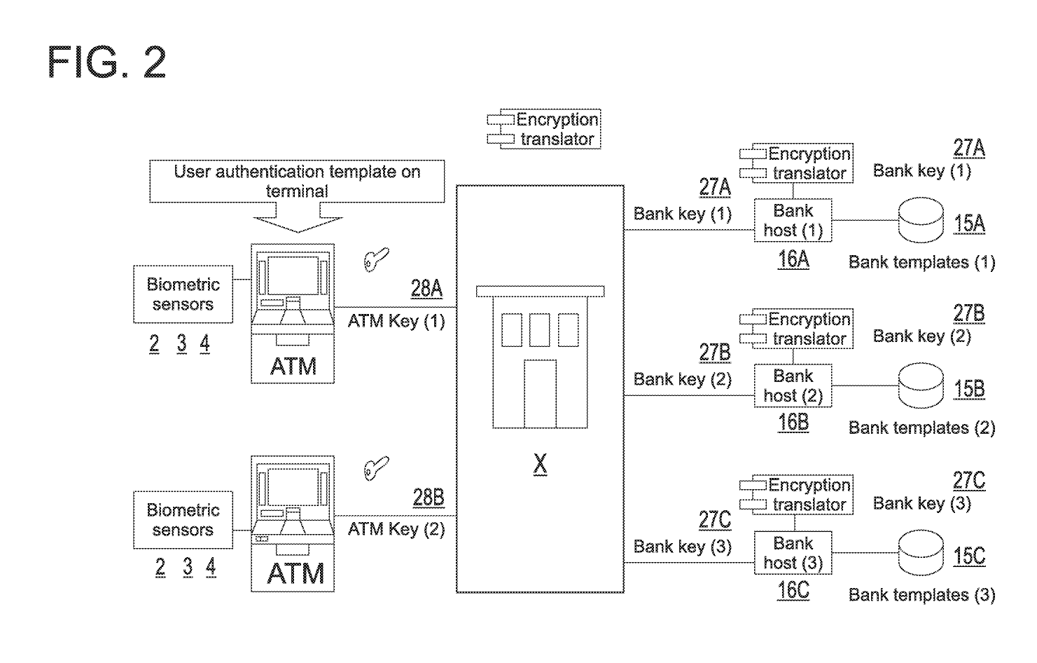

The biometric encrypted template is an important identification of the User U and needs to be securely stored and transported by the biometric key defined between the financial institution 16 Host and Company “X”, being translated on the Host of Company “X” for the ATM key and, subsequently, submitted to the requesting ATM. Thus, a security architecture is defined for transporting the referred templates between the financial institution and software of biometric devices of ATMs from the Company “X” (as it may be understood by observing FIG. 2).

The Company “X” performs biometric authentications applied in market ATM 1, for users of financial institutions, through information of physical characteristics of each user for preferably three market biometric authentication technologies being used, for example, fingerprint sensor 4, biometric authentication by veins (using palm vein sensors 2), or finger vein 3.

The present system also enables transactions to be performed requesting only biometric authentication with the market technology selected by the financial institution (such as palm vein 2, finger vein 3 or fingerprint 4) and/or requesting contingency security mechanisms (positive identification, TAN CODE and TOKEN), or even further, to be performed requesting the combination of security devices and mechanisms, i.e., as example: biometry and card password; biometry and positive identification; biometry, positive identification, TAN CODE and/or TOKEN; no biometry with card password, Positive Identification, “TAN CODE” and TOKEN; or even further, only biometry.

The invention enables the financial institution to select security devices and/or biometric technology to be used on transaction authorization. Upon logging the User U, through its identification of which financial institution that the User U is linked, the ATM (1A or 1B) verifies the financial institution (16A or 16B or 16C) to search for information regarding which security devices will be used on transaction authorization. In this information query by security devices, the ATM (1A or 1B) submits information from biometric sensors that are present and available to be used (palm vein 2, finger vein 3 and/or fingerprint 4) during the transaction authorization of the User U. The financial institution (16A or 16B or 16C) verifies the biometric sensors available (sensors 2, 3 and/or 4) and one of the sensors corresponds to the biometric technology selected for the referred User U and retrieves the security information that will be used on transaction authentication (biometric technology selected by the financial institution (16A or 16B or 16C)).

The present invention also starts the transportation on security of personal characteristics. For transportation of personal characteristics (biometric templates 15A or 15B or 15C) of User Us, a biometric key (27A or 27B or 27C) between the financial institution (16A or 16B or 16C) and the Host of the Company “X”, and a key (28A or 28B) between the Host of the Company “X” and the ATM (1A or 1B) is defined, this key being periodically changed.

Regarding the security solution, the biometric template (15A or 15B or 15C) is an important identification of the User U and needs to be securely stored and transported by the biometric key (27A or 27B or 27C) defined between the Host of the Company “X” and the financial institution (16A or 16B or 16C). The template is then translated on the Host of the Company “X” for the key (28A or 28B) of the ATM (1A or 1B) and then submitted to the requesting ATM (1A or 1B). Thus, a security architecture is defined for transportation of the referred biometric templates (15A or 15B or 15C) between the financial institution (16A or 16B or 16C) and the ATMs (1A or 1B) of the Company “X”.

The present invention monitors one, two or three biometric sensors present on the ATM. It enables to monitor which market biometric technologies (palm vein 2, finger vein 3 and/or fingerprint 4) are present on the ATM equipment (1A or 1B) and the respective states (present, operable, inoperable or disconnected sensor from the ATM CPU).

This invention provides a set of biometric sensors to perform biometric authentication 14 incorporated to an ATM 1 to enable financial institutions to select security devices and biometric technology that will be used for transaction authorization of the User U on ATM equipment 1. The set of biometric sensors that enable biometric authentication 14 allow the ATM equipment 1 to search for registration information 17 and biometric templates 15 on the financial institution 16 indicating on the request message 17, the biometric technologies (biometric sensors 2, 3 and/or 4 installed), the respective types and states of biometric sensors (operable or not). The financial institution 16 verifies the type of biometric sensors (2, 3 and/or 4) installed on the ATM 1 and selects security devices and/or the biometric technology for transaction authorization of the User U.

In this moment, other security devices might be submitted by the financial institution 16 to be captured on the ATM 1, such as, for example, the card password, the positive identification or access letter, the TAN CODE and the TOKEN.

Thus, the system is presented positively flexible and configurable for usage of security devices and/or biometric technologies (2, 3 and/or 4) in ATMs equipment 1. The system enables financial institutions to select biometric technologies on the market (2, 3 and/or 4), and keep performing transactions on ATMs equipment 1 of the Company “X” using the security devices and biometric technologies used in their networks. Examples: requesting only biometric authentication 14; transactions performed requesting contingency devices—positive identification, TAN CODE and TOKEN; transactions performed requesting the combination of following devices: biometry and card password; biometry and positive identification; biometry, card identification, TAN CODE or TOKEN; no biometry with card password, positive identification, TAN CODE and TOKEN, or only biometry.

Regarding the macro validation sequence of the User U with biometric authentication, the User U starts the session on the ATM—example: inserts card 18 for magnetic stripe scanning; the ATM requests to the financial institution 16 the registration information 17 of the User U; then the ATM 1 receives registration information 17A (smart card treatment, biometry and other security devices); subsequently, the ATM requests to insert card 18 and validates 21 the Smart Card CHIP of the User U card; requests the User U to position its finger or hand palm to perform the biometric authentication 14 of the User U; requests and captures the password 23 of the User U; requests the selection of transaction, value, requests authorization and complete the transaction.

Regarding biometric errors 25 flagged on the user biometric authentication on ATM 1, are provided errors on the biometric template 17A submitted by the financial institution 16; error on the User U authentication—different biometry from the registered on financial institution 16; biometry scanning timeout of the User U on ATM and cancellation requested by the User U while scanning biometry.

When one of these errors occur, the ATM submits incident 26 in real time to the financial institution 16.

Only for example purposes, the biometric treatment with hand palm scanning error is mentioned, with the following procedures: biometric sensor 2 is enabled for hand palm scanning; requests the User U to position its hand for scanning; requests the User U not to move its hand palm until the scan and authentication is completed (match execution); then, an error occurs while executing the Match—failed attempt of biometric authentication of the User U, unsuccessful hand palm scanning [hand scanned with template (right hand) and hand scanned with template (left hand)].

With this incident, the amount of biometric scanning errors is flagged. Then, the biometric sensor is once again enabled for hand palm scanning; requests the User U to position its hand for scanning again, reminding that the hand selection for scanning will always be made by the user; if there is a proper scan—requests the User U not to move its hand palm until the match is completed (hand palm authentication); error occurs when performing the match—error on the User U biometric authentication attempt, considering that the hand palm scan was successfully performed and the authentication failed [hand scanned with template (right hand) and hand scanned with template (left hand)].

When it occurs, the amount of biometric scan errors is updated, the biometric sensor is enabled once again for hand palm scanning, requesting the User U to position its hand once again for scanning, being the hand selection for scanning made by the user.

It requests the User U not to move its hand palm until scanning and the match (hand palm authentication) are completed; new transaction completed with authentication error (after three attempts of biometric scanning—capture and authentication).

When the third error occurs, the referred incident 26 is submitted to flag the User U biometric authentication error. A screen is displayed to the User U reporting the error and an error incident is submitted to the financial institution.

The amount of biometric scanning errors is updated and the sensor becomes unavailable for this User U, considering that for the “unavailable sensor” incident some rules are provided, among which the cable disconnection of ATM CPU biometric sensor, i.e., the biometric sensor is monitored via “XFS” commands and the triggering of this sensor must disable the biometric sensor. The operation restart of the biometric sensor (2, 3 or 4) is performed only with operation tests (remote or local).

Moreover, it becomes unavailable as well when a number of consecutive biometric validation errors occurs, i.e., the number of possible errors is configured on the Host of the Company “X” and is submitted via communication network to the ATM. Errors are counted whenever the biometric scanning error occurs, regardless if it happened to one or several users. Each unsuccessful hand palm-scanning attempt is accounted as error. When an OK scan occurs (capture and authentication OK), the amount of errors returns to zero.

In cases of unavailable biometric sensors, on the start of a transaction, the ATM submits the information query message 17 to the financial institution 16 with the information that sensors (palm Vein 2, Finger Vein 3 and Fingerprint 4) are present, but inoperative for use.

The financial institution 16 might submit the answer of the information query request 17A with the security data currently used to validate the user-IDPOS/TAN CODE/TOKEN. Transaction authorization will be performed as if the ATM did not have the biometric sensor (2, 3 or 4) installed.

Information of installed biometric sensors, available and unavailable, is submitted by the ATM 1 system to monitoring systems of the Company “X”.

The information submitted on biometric sensors monitoring are:

1. The status of sensors installed on the ATM that are:
sensor status: inexistent; operative; inoperative; or disconnected.
2. The monitoring of sensors that is performed by the ATM 1 that scans statuses and submits it to ATM monitoring systems of the Company “X”.

Regarding transaction processing, it is worth underlining that transaction records reporting that biometric authentication occurred on the ATM and the transaction base storage of the Company “X” are processed and displayed in managerial reports.

The system starts operational functions (ATM supervisor), i.e., the operational functions that allow technicians of the Company “X” to diagnose and correct problems on biometric sensors (2, 3 and/or 4), local or remotely.

The system started operational functions, which are sensor error diagnostic, biometric sensor tests and synchronization of biometric keys (28A or 28B), where the sensor error diagnostic provides, in turn, the diagnostic function of the operator menu for biometric sensor error flagging and automatic call for execution of problem correction function (biometric sensor tests); and alteration of diagnostic function of operator menu to flag update error of biometric keys on ATM and automatic call to force the update of keys (28A or 28B).

A second operational function provides biometric sensors tests (2, 3 and/or 4), performed by biometric data capture and validation execution.

And further yet, one last operational function consists on synchronization of biometric keys (28A or 28B) that forces the exchange of biometric keys with the server of the Company “X” and it can be performed automatically or by remote operation.

Although the invention is detailed, it is important to understand that it does not limit its application to details and stages herein described. The invention is capable of other modalities and being practiced or executed in a variety of methods. It must be understood that the terminology herein applied is for description purposes and not for limitation.

### LEGEND OF THE FIGURES

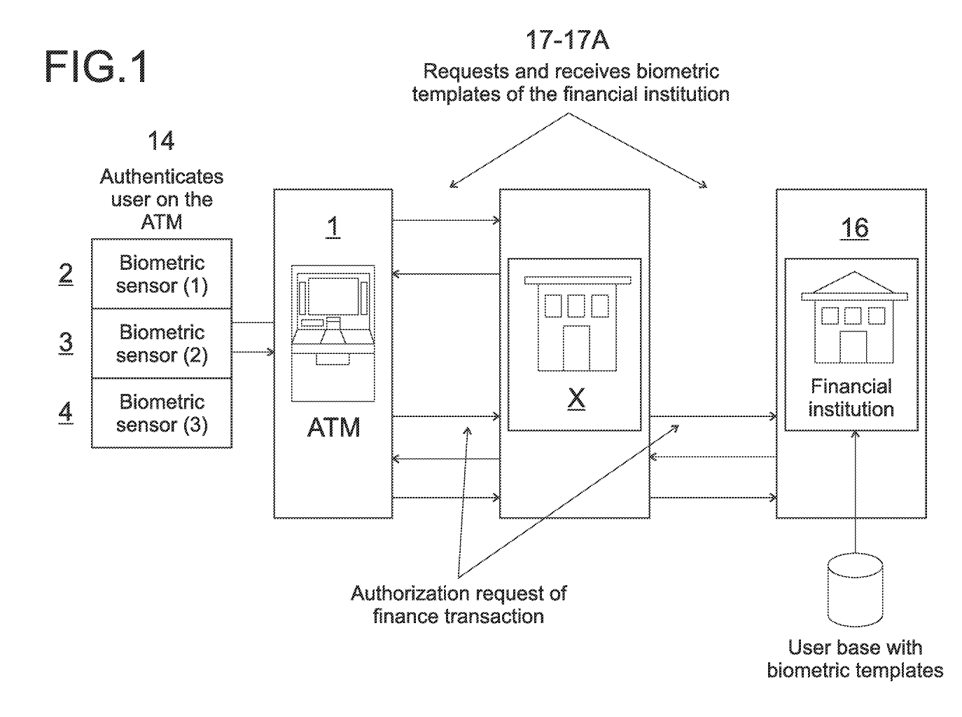

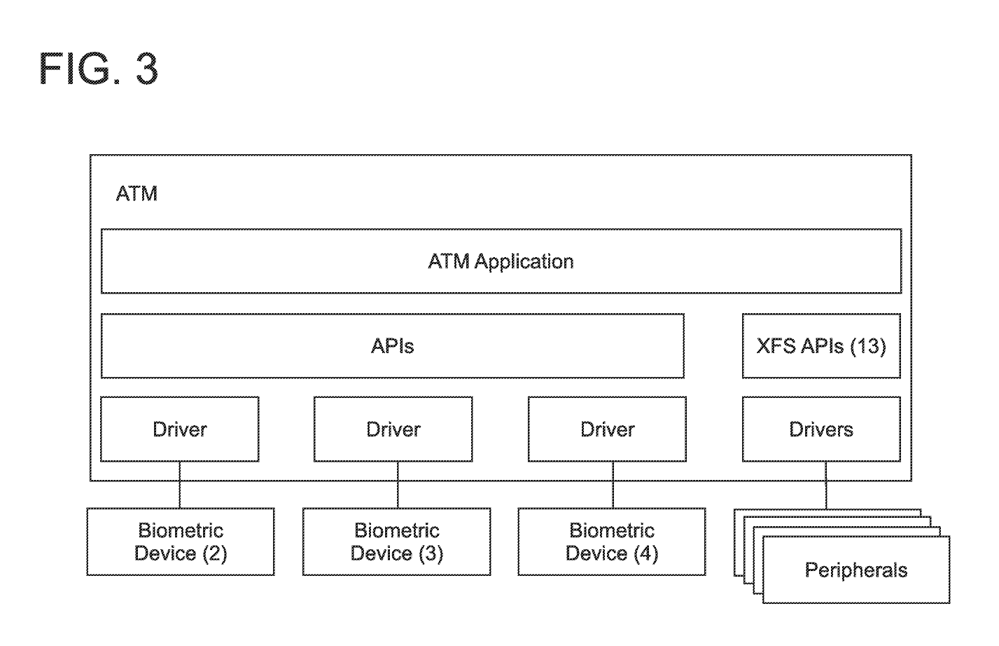

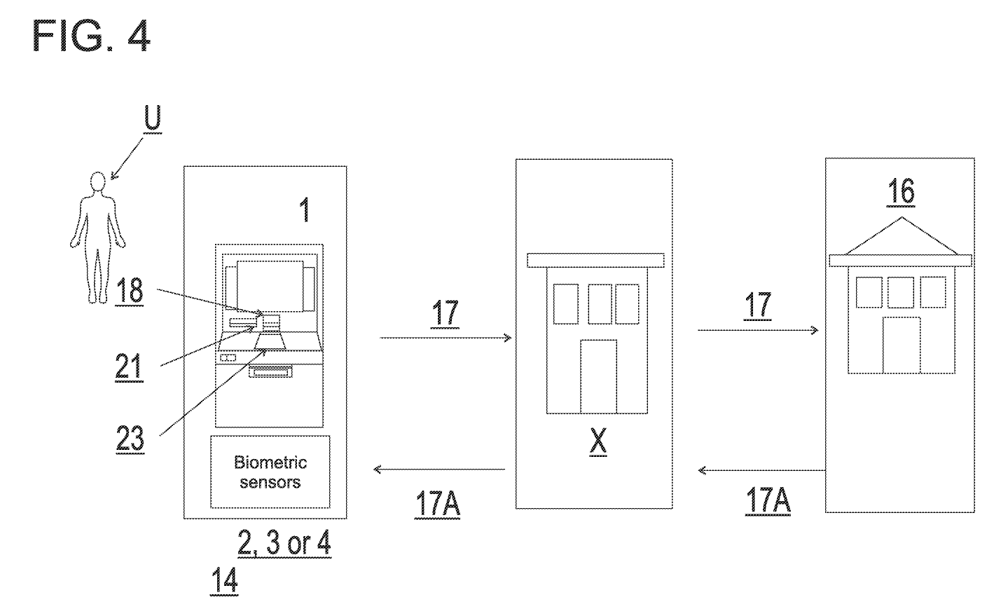

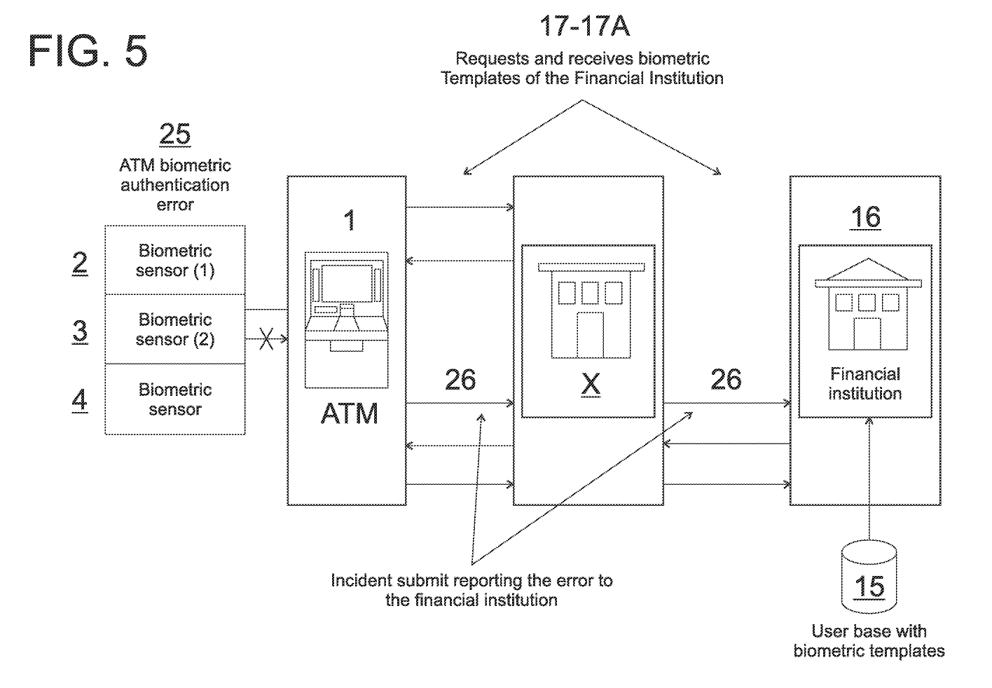

FIG. 1
(TX1): “Authenticates user on the ATM”
(TX2): “Requests and receives biometric templates of the financial institution”
(SB1): “Biometric sensor (1)”
(SB2): “Biometric sensor (2)”
(SB3): “Biometric sensor (3)”
(TX3): “Authorization request of finance transaction”
(TX4): “User base with biometric templates”
(IF): “Financial institution”
FIG. 2
(TX5): “User authentication template on terminal”
(SB): “Biometric sensors”
(CH1): “ATM Key 1”
(CH2): “ATM Key (2)”
(TC): “Encryption translator”;
(CB1): “Bank key (1)”
(HB1): “Bank Host (1)”
(TB1): “Bank templates (1)”
(CB2): “Bank key (2)”
(HB2): “Bank host (2)”
(TB2): “Bank templates (2)”
(CB3): “Bank key (3)”
(HB3): “Bank host (3)”
(TB3): “Bank templates (3)”
FIG. 3
(1): “ATM”
(AA): “ATM Application”
(AP): “APIs”
(DB2): “Biometric device (2)”
(DB3): “Biometric device (3)”
(DB4): “Biometric device (4)”
(P): “Peripherals”
(AX): “XFS APIs (13)”
(DR): “Drivers”
FIG. 4
(SB): “Biometric sensors”
FIG. 5
(TX2): “Requests and receives biometric Templates of the
Financial Institution”
(SB1): “Biometric sensor (1)”
(TX6): “ATM biometric authentication error”
(SB2): “Biometric sensor (2)”
(SB): “Biometric sensor”
(TX7): “Incident submit reporting the error to the financial institution”
(BU): “User base with biometric templates”
(IF): “Financial institution”.

1. “MULTIBANK BIOMETRIC AUTHENTICATION SYSTEM APPLIED IN AUTOMATIC TELLER MACHINES WITH BIOMETRIC SENSORS”, wherein the biometric authentication of users of multibank ATMs (1) is allowed by applying, preferably, three biometric sensors (2), (3) and (4); this system enables transactions to be performed on ATM (1), (1A) and (1B) requesting only biometric authentication or requesting contingency devices that include positive identification, TAN CODE and TOKEN, or even further, to be performed requesting the combination of biometry and card password devices; biometry and positive identification; biometry, positive identification, TAN CODE or TOKEN; no biometry with card password, positive identification, TAN CODE and TOKEN; or even further, only biometry, searching for biometric registration information of the user, on the financial institution (16A), (16B) and (16C), authenticating the user and authorizing the transaction by biometry.

2. “MULTIBANK BIOMETRIC AUTHENTICATION SYSTEM APPLIED IN AUTOMATIC TELLER MACHINES WITH BIOMETRIC SENSORS” according to claim 1, wherein the adoption of a biometric key (27A), (27B) and (27C) is provided between the financial institution (16A), (16B) and (16C) and the Host of a Company “X” and a key for each ATM (1A) and (1B) between the Host of the Company “X” and ATMs, this key being periodically changed; the encrypted biometric template (17A) is stored and transported by the biometric key defined between the financial institution Host (16A), (16B) and (16C) and the Company “X”, being translated on the Host of the Company “X” for the ATM key (28A) or (28B) and, subsequently, are submitted to the requesting ATM (1A) or (1B); use of biometric sensors (2), (3) and/or (4) on ATM (1); the system monitors the disconnection of the CPU sensor cable via alarm board of the ATM (1), considering that the sensor cable disconnection scanning is performed by running “SIU” command of the “XFS APIs” layer.

3. “MULTIBANK BIOMETRIC AUTHENTICATION SYSTEM APPLIED IN AUTOMATIC TELLER MACHINES WITH BIOMETRIC SENSORS” according to claim 1, wherein the registration information search (17) occurs by biometric templates (15A), (15B) or (15C) on the financial institution (16A), (16B) or (16C); the ATM (1A) or (1B) requests (17) to the financial institution (16A), (16B) or (16C), the user (U) registration information reporting that the ATM (1A) or (1B) has biometric sensors (2), (3) and (4) installed and the respective types and manufacturers; the financial institution (16A), (16B) or (16C) validates types and manufacturers of sensors (2), (3) and (4) installed on the ATM (1A) or (1B) verify if the user (U) has biometry registered and submits (17a) biometric templates (15A), (15B) or (15C) corresponding to financial institution definition (16A), (16B) or (16C) and registered in its biometric template base (15A), (15B) or (15C).

4. “MULTIBANK BIOMETRIC AUTHENTICATION SYSTEM APPLIED IN AUTOMATIC TELLER MACHINES WITH BIOMETRIC SENSORS” according to claim 1, wherein other financial institutions (16A), (16B) or (16C) allow to use other security devices to be captured on the ATM (1A) or (1B), such as, for example, card password, positive identification or access letter, TAN CODE and TOKEN.

5. “MULTIBANK BIOMETRIC AUTHENTICATION SYSTEM APPLIED IN AUTOMATIC TELLER MACHINES WITH BIOMETRIC SENSORS” according to claim 1, wherein regarding the user (U) authentication, the ATM activates the sensor (2), (3) or (4) corresponding to templates (17A) submitted by the financial institution (16A), (16B) or (16C), these sensors can be of Palm Vein (2), Finger Vein (3) or Fingerprint (4) types and requests the user (U) to position its finger or hand palm on the sensor and perform biometric authentication (14); the transaction authorization with biometry occurs in such a way that upon authorization request of the financial transaction is informed that there was a biometric authentication of this user (U) and it was submitted to authorization, the other security devices requested upon consultation; the biometric authentication must respect some conditions or rules so it may occur on a proper manner, considering that, the user (U) has a given number “X” of attempts to scan and perform biometric authentication, where “X” is a authentication attempt parameter configured on the Host of the Company “X”.

6. “MULTIBANK BIOMETRIC AUTHENTICATION SYSTEM APPLIED IN AUTOMATIC TELLER MACHINES WITH BIOMETRIC SENSORS” according to claim 1, wherein it is provided that the first rule covers the scanning and authentication times: the amount of attempts and the time for scanning and authentication are configurable; the ATM (1A) or (1B) cancels the attempt of biometry scan of the user (U) after a number “Y” of seconds configured on the Host of the Company “X” waiting for positioning of finger or hand palm; this ATM (1A) or (1B) flags the user (U) delay error and returns to section start to wait a new card insertion; then, the ATM (1A) or (1B) cancels the scan and authentication attempts of the user (U) after three hand palm authentication errors.

7. “MULTIBANK BIOMETRIC AUTHENTICATION SYSTEM APPLIED IN AUTOMATIC TELLER MACHINES WITH BIOMETRIC SENSORS” according to claim 1, wherein regarding the macro validation sequence of the user (U) with biometric authentication, the user (U) inserts the card (18) for magnetic stripe scanning; the ATM (1A) or (1B) requests to the financial institution (16A), (16B) or (16C) the registration information of the user (U); then the ATM receives registration information (17A), smart card treatment, biometry and other security devices; subsequently, the ATM requests to insert card (18) and validates (21) the Smart Card CHIP of the user (U) card; requests the user (U) to position its finger or hand palm to perform the biometric authentication (14) of the user (U); requests and captures the password (23) of the user (U); requests the selection of transaction, value, requests authorization and complete the transaction.

8. “MULTIBANK BIOMETRIC AUTHENTICATION SYSTEM APPLIED IN AUTOMATIC TELLER MACHINES WITH BIOMETRIC SENSORS” according to claim 1, wherein regarding the errors (25) flagged on the user (U) biometric authentication on the ATM (1), it is able to predict template (17A) errors submitted by the financial institution (16); error on the user (U) authentication—different biometry from the registered one on the financial institution (16); biometry scanning timeout of the user (U) on the ATM (1) and cancellation requested by the user (U) while scanning biometry, considering that when one of these errors occur, the ATM submits incident (26) in real time to the financial institution (16); the amount of biometric scan errors is flagged and the biometric sensor is once again enabled for hand palm scanning; requests the user (U)—to position its hand once again for scanning; if the scanning is OK—requests the user (U) not to move its hand palm until the match is completed, which is the hand palm authentication; an error occurs when performing the match—error on the user (U) biometric authentication attempt, considering that the hand palm scan was successfully performed and the authentication failed, on cases of hand palm scanned with templates (17a); when it occurs, the amount of biometric scan errors is updated, the biometric sensor is enabled once again for hand palm scanning, requesting the user (U) to position its hand once again for scanning, then it requests the user (U) not to move its hand palm until scanning and hand palm authentication are completed; finally, when the third error occurs, this incident (26) in submitted to flag the user (U) biometric authentication failure and the problem reason is created to flag the problem.

9. “MULTIBANK BIOMETRIC AUTHENTICATION SYSTEM APPLIED IN AUTOMATIC TELLER MACHINES WITH BIOMETRIC SENSORS” according to claim 1, wherein after a given number “X” of biometric scan errors, the sensor becomes unavailable for this user (U), considering that for the “Unavailable sensor” incident some rules are provided, among which the cable disconnection of ATM CPU; the operation restart of the biometric sensor is performed only with operation tests (remote or local); it is indispensable as well when there is a number of biometric validation consecutive errors, where the maximum errors possible is configured on the Host of the Company “X” and is submitted via communication network to ATM; amount of consecutive errors of biometric scan that exceed the error threshold value configured on the capture point configurator; errors are counted whenever the biometric scanning error occurs, regardless if it happened to one or several users (U); each unsuccessful hand palm scanning attempt is accounted as error; on first scan with proper capture and authentication, the amount of errors returns to zero; in cases of unavailable biometric sensors, on the start of a transaction, the ATM submits the information query message (17) to the financial institution (16) with the information that sensors palm Vein (2), finger Vein (3) and fingerprint (4) are present, but inoperative for use; thus, the financial institution (16) might submit the answer of the information query request (17A) with the security data currently used to validate the user (U)-IDPOS/TAN CODE/TOKEN; and the transaction authorization will be granted as if the ATM had no biometric sensor (2), (3) or (4) installed.

10. “MULTIBANK BIOMETRIC AUTHENTICATION SYSTEM APPLIED IN AUTOMATIC TELLER MACHINES WITH BIOMETRIC SENSORS” according to claim 1, wherein the information of available and unavailable sensors are submitted by the ATM (1) monitoring agent, software installed on ATM that monitors equipment peripherals, for monitoring systems of the Company “X”, considering that the information, which are submitted on TRAP biometric sensor monitoring are: the status of sensors installed on the ATM that, in turn, are palm vein: sensor status: inexistent; operative; inoperative; or disconnected. the sensor status: returns from BIOAPIs; SDK version; the finger vein: sensor status: inexistent; operative; inoperative; or disconnected; the sensor status: returns from BIOAPIs; SDK version: fingerprint: sensor status: inexistent; operative; inoperative; or disconnected; sensor status: returns from BIOAPIs; SDK version; and the sensor monitoring that is performed by the “ATM monitoring agent”, which is the software installed on the ATM that scans statuses and submits to ATM monitoring systems, and statuses are submitted via TRAPs for monitoring systems, i.e., SNMP protocol.

11. “MULTIBANK BIOMETRIC AUTHENTICATION SYSTEM APPLIED IN AUTOMATIC TELLER MACHINES WITH BIOMETRIC SENSORS” according to claim 1, wherein regarding the transaction processing, transaction records reporting that biometric authentication occurred on the ATM and the transaction base storage of the Company “X” and on the financial institutions (16) are processed and displayed in managerial reports.

12. “MULTIBANK BIOMETRIC AUTHENTICATION SYSTEM APPLIED IN AUTOMATIC TELLER MACHINES WITH BIOMETRIC SENSORS” according to claim 1, wherein regarding the security solution, the biometric template (17A) is transported by a security architecture for transportation of templates between financial institutions and the ATMs of the Company “X”, where this architecture is resumed in a biometric key (27A), (27B) and (27C) defined between the financial institution (16A), (16B) e (16C) and Host of the Company “X” and a key (28A) and (28B) for each ATM between the Host of the Company “X” and ATMs (1A) and (1B), considering that the ATM biometric key (28A) e (28B) must be periodically changed; financial institutions (16A), (16B) and (16C) submit encrypted templates (17A) by the biometric key (27A), (27B) or (27C) defined between the Host of financial institution (16A), (16B) or (16C) and the Company “X” and the templates encrypted by the Company-bank key are translated into the Host of Company “X” for the ATM key (28A) or (28B), considering that templates (15A), (15B) or (15C) translated for templates with ATM key (28A) or (28B) are submitted by Host of the Company “X” for the ATM (1A) or (1B) that requested the templates (17).

13. “MULTIBANK BIOMETRIC AUTHENTICATION SYSTEM APPLIED IN AUTOMATIC TELLER MACHINES WITH BIOMETRIC SENSORS” according to claim 1, wherein a solution is provided for operational functions that enable technicians of the Company “X” to diagnose and correct problems on biometric sensors; said operational functions comprise the sensor error diagnostic, biometric sensor tests and synchronization of biometric keys, where the sensor error diagnostic, provides in its turn, the diagnostic function of operator menu for flagging the biometric sensor error and automatic call for execution of problem correction function; and the alteration of diagnostic function of operator menu to flag update error of biometric keys on ATM and automatic call to force the update of keys (28A) or (28B); a second operational function are the biometric sensors tests, which are performed by biometric data capture of finger or hand palm image of the Operator/Technician and validation execution; the biometric sensor validation test can only be performed locally; unable to perform validation remotely; and even further, one last operational function is the synchronization of biometric keys that forces the exchange of biometric keys with the server of the Company “X” and it can be performed automatically or by remote operation or with the presence of the operator on the ATM running the operational function of key synchronism.
